(19) United States
(12) Patent Application Publication
(10) Pub. No.: US 2026/0251606 A1
(43) Pub. Date: Aug. 27, 2026

(54) SPRAY SENSOR SYSTEM

(71) Applicant: BIOSCOUT PTY LTD, New South Wales (AU)

(72) Inventor: Thomas J MCMENAMIN, Darlington (AU)

(73) Assignee: BIOSCOUT PTY LTD, New South Wales (AU)

(21) Appl. No.: 19/151,954

(22) PCT Filed: Jan. 31, 2024
(86) PCT No.: PCT/AU2024/050060

§ 371 Date: Jul. 29, 2025

(30) Foreign Application Priority Data
Jan. 31, 2023 (AU) 2023900221

(51) Int. Cl. G01N 27/22; A01M 7/00

(52) U.S. Cl. CPC G01N 27/223; A01M 7/0096; G01N 27/227

(57) ABSTRACT

The disclosure herein relates to a sensing device for sensing wetness, the sensing device comprising a sensor, the sensor having a flexible main portion, the main portion comprising one or more sensing regions, the sensing device including a sensing arrangement for each of the one or more sensing regions.

### TECHNICAL FIELD

The disclosure herein relates to a sensing device for sensing wetness, the sensing device comprising a sensor, the sensor having a flexible main portion, the main portion comprising one or more sensing regions, the sensing device including a sensing arrangement for each of the one or more sensing regions.

### BACKGROUND ART

It is to be understood that, if any prior art is referred to herein, such reference does not constitute an admission that the prior art forms a part of the common general knowledge in the art, in Australia or any other country.

The distribution and coverage of liquids sprayed in a crop field in an agricultural setting are key factors that help farmers maximise their expected yield in a given harvest cycle. Typically, farmers would aim to optimise their water usage rate by using as little spray liquid as possible (which is already a significant operating cost burden) while also being able to achieve the maximum desired level of coverage possible across a given crop field.

Current methods of analysing the spray distribution and coverage involve the use of spray papers, akin to litmus paper tests, that provide very limited information. These existing spray papers are single use items. They work by undergoing discolouration in the presence of moisture. However, they do not provide quantitative in-situ information regarding the coverage or amount of the moisture and are not useful when it comes to optimising the farmer's spraying operations. There are also crop field leaf wetness sensors available that measure the wetness of crop fields during a spray event, but all lack the ability to provide tangible data that can help optimise the farmer's use of spray methods. These existing leaf wetness sensors simply return a single number, that is typically compared with a threshold to give an overall number of the “hours of leaf wetness”. However, these calculations are not always accurate. Their baseline and peak readings are inconsistent and insufficient to provide quantitative feedback to a farmer as they do not know if the wetness which occur is due to condensation, rain, or spray and they do not know if the sensors themselves are dirty, or in physical contact with other leaves in the canopy. These wetness sensors are typically not placed in the canopy itself but are rather a plug-in add-on to a standard weather station that sits out in a cleared area. There is therefore a lack of effective data-acquisition techniques and/or methods available that are able to provide key metrics related to the distribution and coverage of sprays used in a crop field. These same methods also lack the ability to provide details related to the coverage and quality of the spray used for a given individual leaf, or provide meaningful recommendations on how best to improve them.

### SUMMARY

One aspect of the invention disclosed herein relates to a sensing device for sensing wetness, the sensing device comprising a sensor, the sensor having a main portion, the main portion comprising more than one sensing regions, the sensing device including a sensing arrangement for each of the more than one sensing regions such that the wetness of each sensing region is independently sensed. The main portion may be flexible.

In some forms, the flexible main portion comprises a first face and a second face.

In some forms, either one, or both of, the first and second faces comprise(s) more than one sensing regions.

In some forms, the main portion has a layered structure.

In some forms, the layered structure includes at least a sensing layer and an insulating layer provided over the sensing layer.

In some forms, the main portion is shaped like a leaf. The sensor may be shaped by the leaf of a crop in relation to which the sensing device is intended to measure wetness. The sensor may be configured to emulate mechanical, thermal or evaporative responses of a leaf of the crop to external forces or environmental conditions.

In some forms, the sensor comprises a stalk region.

In some forms, the stalk region is configured to transmit data from the more than one sensing regions.

In some forms, the sensor comprises a margin region around the main portion.

In some forms, the sensor furthers comprises a controller device which is in data communication with the sensor.

In some forms, the controller is configured to do one or more of: process data from the sensor, store data from the sensor, or transmit data from the sensor.

In some forms, the controller further comprises one or more environmental sensors configured for measuring, while in use, environmental data.

In some forms, measurement(s) from the more than one sensing regions are adjusted to compensate for environmental effects on the basis of the environmental data.

In some forms, the controller further comprises an accelerometer.

In some forms, the controller further comprise a GPS module.

In another aspect of the invention disclosed herein, the aspect relates to a spray sensing system configured to measure coverage of a spray applied to a crop, comprising a plurality of sensing devices.

In some forms, the flexible main portion of each sensing device generally shaped like a leaf.

In some forms, the main portion of the sensor of each sensing device is shaped like a leaf of the crop, to emulate the mechanical, thermal or evaporative response of a leaf of the crop.

In some forms, the spray sensing system further comprises a gateway device configured to receive data from the plurality of sensing devices.

In some forms, the gateway device comprises a processor which is configured to execute machine instructions to analyse data the plurality of sensing devices.

In some forms, the gateway device is further configured to receive rainfall information.

In some forms, the gateway comprises a wireless communication module, for data communication with the plurality of sensing devices.

In some forms, the wireless communication module is configured to provide lower power data transfer.

In some forms, the wireless communication module is configured via a short-or near-range communication protocol.

In some forms, the gateway is configured to be in wireless communication with a remote computing system.

In some forms, the gateway device further comprises one or more environmental sensors.

In some forms, the plurality of sensing devices are orientated substantially in the same direction.

In some forms, the plurality of sensing devices are arranged in a plurality of sets, wherein each set comprises multiple sensing devices arranged or located in accordance with spray zones defined by the user.

In another aspect of the invention disclosed herein, the aspect relates to a method of measuring coverage of a spray applied to a field of crop, the method comprising installing at least one spraying system, so that sensing devices of the spraying system are attached to a canopy of the crops; processing information data from the gateway device to determine a spray coverage.

In some forms, the method further comprises processing measurements from the sensor of each sensing device and providing results from the processing to the gateway device.

In some forms, the sensing devices are installed at multiple heights.

In some forms, the at least one spray sensing system is configured to have a sleep mode in which the at least one spraying system obtains sensor readings but environment sensor readings are not acquired.

In some forms, the at least one spray sensing system is configured to enter a second mode of operation when a first wake-up condition is met.

In some forms, the at least one spray sensing system is configured to enter a third mode of operation when a second wake-up condition is met.

In some forms, the system comprises a logic for switching between the sleep, second, and third modes.

In some forms, the logic comprises algorithms for setting parameters to define an accelerated reading operation.

### BRIEF DESCRIPTION OF THE DRAWINGS

Embodiments will now be described by way of example only, with reference to the accompanying drawings in which

FIG. 1 shows a top plan view of a sensing device in accordance with an embodiment of the present invention.

FIG. 2A-2C show schematic diagrams of the sensing regions of the sensing device shown in FIG. 1.

FIG. 3 shows a labelled schematic diagram of the one or more sensing regions of the sensing device shown in FIG. 1.

FIG. 4 shows a table summary of an example of the material composition of the layers of the sensor in the sensing device.

FIG. 5 shows a perspective view of a sensing system comprising a plurality of sensing devices and a gateway device, in accordance with an embodiment of the present invention.

FIG. 6 shows a block diagram representation of the sensor and controller components of the sensing device, in accordance with an embodiment of the present invention.

FIG. 7 shows a block diagram representation of the various components of the gateway device, in accordance with an embodiment of the present invention.

FIG. 8 schematically depicts an example of data pathways between the sensing devices, and the gateway device, and the cloud database.

FIG. 9 schematically depicts a data aggregation model of a single leaf sensing device.

FIG. 10 schematically depicts a data aggregation model of multiple leaf sensing devices and the gateway device.

FIG. 11 schematically depicts a block diagram representation of a flow between the different modes of operation of an embodiment of the spray sensing system.

FIG. 12 schematically depicts a block diagram representation of the “Sleep Mode” operation of a spray sensing system.

FIG. 13 schematically depicts a block diagram representation of the “Spray Detection Mode” operation of a spray sensing system.

FIG. 14 schematically depicts a block representation diagram of the “Normal Mode” operation of a spray sensing system.

FIG. 15 shows an example of sensing devices of a sensing system installed for field use, in accordance with an embodiment of the spray sensing system.

FIG. 16 shows an example of a visual representation of the spray coverage data received from the spray sensing system before a spray event.

FIG. 17 shows an example of a visual representation of the spray coverage data received from the spray sensing system after a spray event.

### DETAILED DESCRIPTION

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings may be arranged, substituted, combined, separated and designed in a wide variety of different configurations, all of which are contemplated in this disclosure.

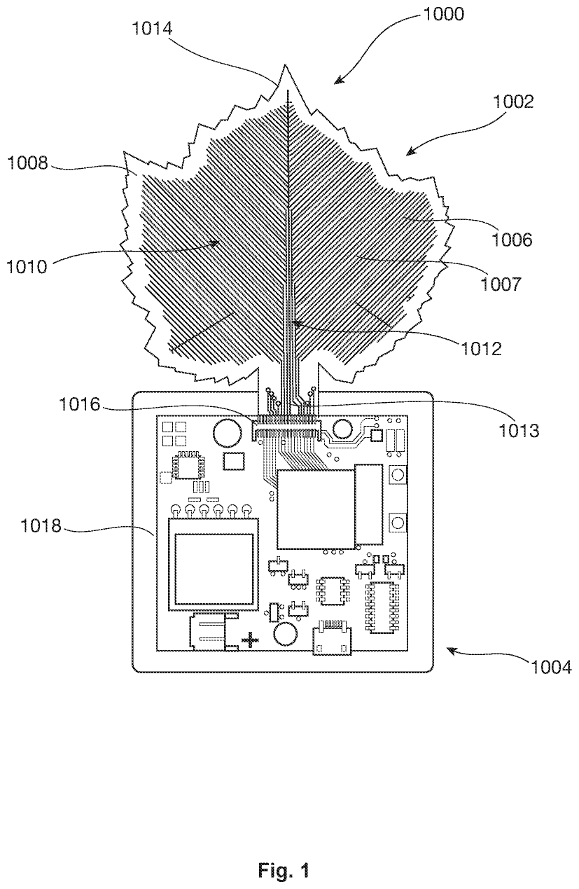

FIG. 1 illustrates an embodiment of a sensing device 1000 in accordance with an embodiment of the present invention. The sensing device 1000 includes a sensor 1002, In a preferred embodiment, the sensor 1002 is flexible in that it can be bent. For example, in embodiments where the sensor 1002 has a planar surface, this means the sensor 1002 may be flexed such that its planar surface can be resiliently bent or curved. The amount of flexibility, i.e., the amount of bending which may be applied to the sensor without it breaking, may be tuned to mimic the crop of interest. If the sensor 1002 is intended to be used for a particular crop, it is preferably configured to have a flexibility which reflects that of the crop, such as a leaf of the crop. This can help the sensor to mimic various behaviours of the crop, such as flapping or vibration when acted upon by external forces from, e.g., the wind, the rain or a spray event. The sensor 1002 may comprise a flexible printed circuit board (PCB) provided with a capacitive sensing arrangement. The sensor 1002 may be leaf-shaped. For instance, the sensor 1002 may be of the same shape as the leaves for the crops for which the spray measurement is being made. The sensing device further includes a controller 1004. The controller 1004 may be an internet of things (IOT) device that can quantitatively measure the moisture content as measured by the sensor 1002 to which the controller 1004 is coupled.

In practice, an array or a plurality of sensing devices 1000 are attached to the crop canopies, for instance by being clipped into wires installed in the canopies. The sensing devices 1000 are installed off the grounds across a crop field. The sensing devices 1000 may be installed at various heights, and the heights may be adjustable throughout the course of the crop field's cycle. The sensor 1002 can be designed or customised to have one or more of specially designed shape, size, and thickness, to best emulate one or more of the mechanical, thermal and evaporative responses, of a real leaf in a crop field. The mechanical response of the real leaves flapping and moving during a spray event can be mimicked by the sensor 1002, which may enable the measurement of the canopy spray penetration. The sensor 1002 can therefore optionally take on any shape required to mimic any crop of interest, e.g., grapes, wheat, grass or apples etc. Further, the leaf-shaped sensor 1002 can also be designed for different growth stages of the same crop, as different products and pests are relevant over the crop lifecycle.

The sensor device 1000 is able to detect spray events (such as pesticide spray events) and measure their effectiveness as defined in one or more parameters such as coverage, canopy penetration, and others, for example by giving a reading of the ‘coverage’ of the spray's liquid substrate on the flexible leaf-shaped sensor 1002. As it will be mentioned later, the leaf-shaped sensors 1002 will in most embodiments have two sides, as many types of leaves have two sides. In these embodiments, the sensors 1002 will preferably include sensing probes on both sides, so that independent measurements may be obtained for each side. This provides insights to farmers about their spray equipment and configuration, and they are therefore able to measure and enhance their pest and disease prevention actions. The determination of the parameters may be performed through various error-rejection means (further disclosed herein).

One or both of the controller elements 1004 and the flexible sensor 1002 of the sensing device 1000 includes components (further disclosed herein) that help improve the accuracy of the assessment of the effectiveness of the spraying events, and they can provide actionable insights to make the required adjustments for improving the spraying effectiveness. The selection and inclusion of the components in the sensing device 1000 can be customised to the crop level. For example, the controller device 1004 can include an environmental sensor configured for measuring the baseline environmental conditions (e.g., humidity, temperature, or rainfall etc) to improve the accuracy of the spray coverage readings. The controller device 1004 can also include an accelerometer configured for measuring the mechanical response (e.g., vibration, leaf angle etc) of the flexible sensor 1002 during a spray event. The controller device 1004 can also include a GPS module configured for mapping the location of the sensor devices 1000. The sensor device 1000 can also include a liquid sensor that can measure other data such as the PH readings, electrical conductivity and/or salinity reading of the spray in real time.

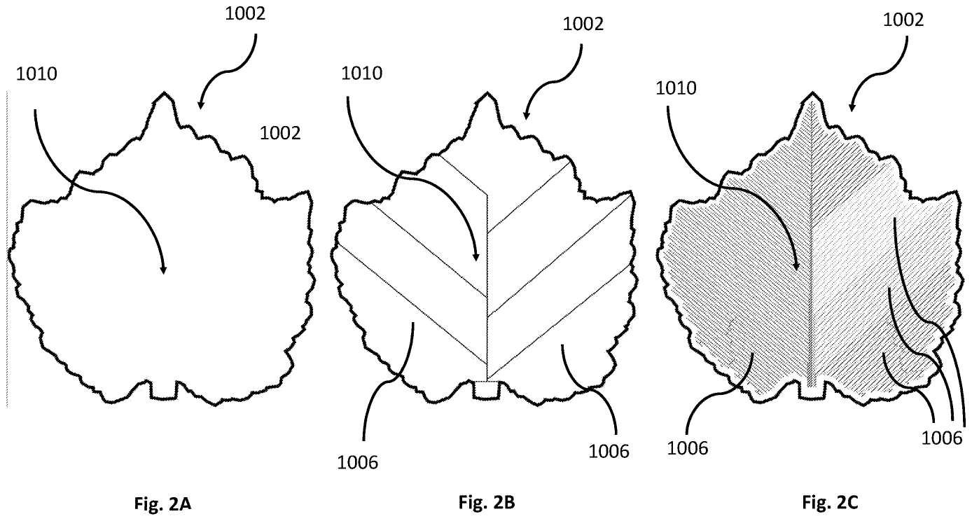

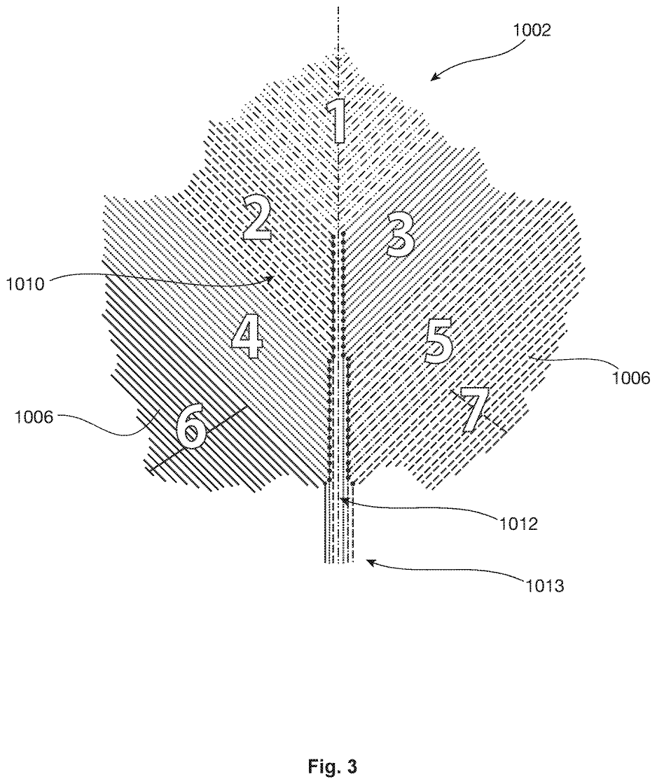

Referring to FIG. 1, in the depicted embodiment, the flexible sensor 1002 of the sensing device 1000 includes a main portion 1010 which includes one or more sensing regions 1006 (better illustrated in FIGS. 2B, 2C and 3). In this example the main portion 1010 is leaf-shaped and further includes a stalk region 1012. The main portion 1010 is connected to a base 1013 in which provides connectivity to the controller element 1004. The stalk region 1012 may be used to locate the conductors to transmit data from the sensing regions 1006. The stalk region 1002 may also be configured so that the overall sensor 1002 can mimic the mechanical properties of the crop of interest, to improve the biomimicry particularly for embodiments where the sensor is designed to mimic the leaf.

In this example a margin region 1008 is provided around the main portion 1010 but this is not an essential feature. In embodiments where the sensor 1002 includes capacitive sensor probes, the margin region 1008 may be configured to provide an electrical ground. This helps to ensure the accurate measurement of capacitance change by the probes, as it is a measure of charge accumulation between the probes of a sensing region and ground. The space between the sensor probes may have located therein probes for the ground connection. Multiple ground probes may be interconnected, so that the one ground connection services all sensing regions. As the margin region 1008 is provided around the “leaf” shape of the sensor, it is advantageous for ensuring a good connectivity to the electrical ground across the leaf.

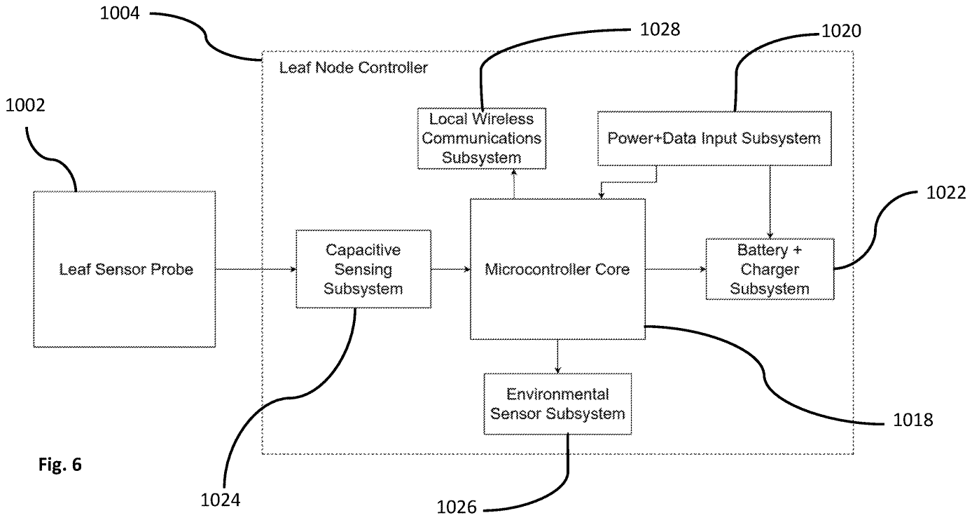

Information is gathered from the one or more sensing regions 1006 of the main portion 1010 and transmitted to the controller element 1004. The base 1013, which in this case is a base of the stalk region 1012, connects the flexible sensor 1002 to a processing device 1018 of the controller element 1004. The processing device 1018 may be a microcontroller core. The connection as depicted is made via a connection port 1016 (better illustrated in the block diagram in FIG. 6). For example, connection will be made via an FPC/FFC Ribbon Cable connector that is able to mate natively with contacts integrated onto the flexible leaf sensor. However other types of connections may be used.

As alluded to above, the flexible sensor 1002 includes a first side 1007 and an opposite second side. One or preferably both of the sides include its own one or more sensing regions 1006. Where both sides include sensing regions 1006, independent readings of the moisture and/or spray quality for the two sides 1007 may be obtained. The configuration or layout of the sensing regions 1006 of the sides may be identical or different and may be designated depending on the structural properties of the leaf of the crop for which the sensor 1002 is to be used. Typically, the sides will be planar sides as the leaves for many crops are planar. However, it may be that in some embodiments the sensor includes non-planar surfaces, for instance emulating stalk shapes. Conceivably, the sensor may have a combination of planar and non-planar regions, depending on the leaf which is being mimicked.

FIGS. 2B, 2C and FIG. 3 schematically illustrates an example of the arrangement of the sensing regions 1006 in the flexible sensor 1002. In this example the flexible sensor 1002 includes 14 sensing regions 1006, including 7 sensing regions on the one side 1007 and 7 sensing regions on the opposite side (not shown). The 7 sensing regions 1006 comprises a region (region 1) located at a tip area of the stalk region 1012. The other 6 regions 1006 (regions 2 to 7) are arranged three on each side of a centreline of the sensor 1002, to which the “stalk” 1012 is generally aligned.

In other forms of the invention, there can be a different number of sensing regions 1006. The number of sensing regions included may be chosen depending on the desired resolution of detail, battery capacity of the sensor devices 1000, or both. In a planar sensor 1002, the use of sensing regions 1006 on both sides of the flexible sensor 1002 can improve the quality of sensor readings and help to reject errors caused by events such as physical contact with another leaf in the canopy.

The parameters and design of the one or more sensing region 1006 may be tuneable or adjustable to optimise the performance of the sensor device 1000. For example, the layout of the one or more sensor regions 1006 can be designed in order to match the biological structure of a crop leaf. For example, many crop leaves may include a distinctly shaped central region 1010 or a margin region 1008, with a number of relatively narrow tips at the margin region 1008. These regions can be susceptible to different diseases and pests. By providing a sensor layout that also includes areas analogous to these regions, and measuring the duration that various regions across the sensor layout are detected as being “wet”, this data may be useful in providing information on potential infection risks, particularly for the susceptible tip and margin areas of the canopy leaves where the sensors are installed. For instance, a higher percentage of wetness for a longer duration being detected in a tip region in the sensor layout, may indicate a higher potential infection risk for the crop. In this way the sensors may be used not just to measure wetness from the spray events, but also monitor indicators of potential health or diseases in the crop. In other forms of the invention, e.g., where no use case-specific layouts are desired, it would be simplest to generate flexible sensors 1002 of identical sizes and/or designs, to minimise electrical calibration and tuning requirements.

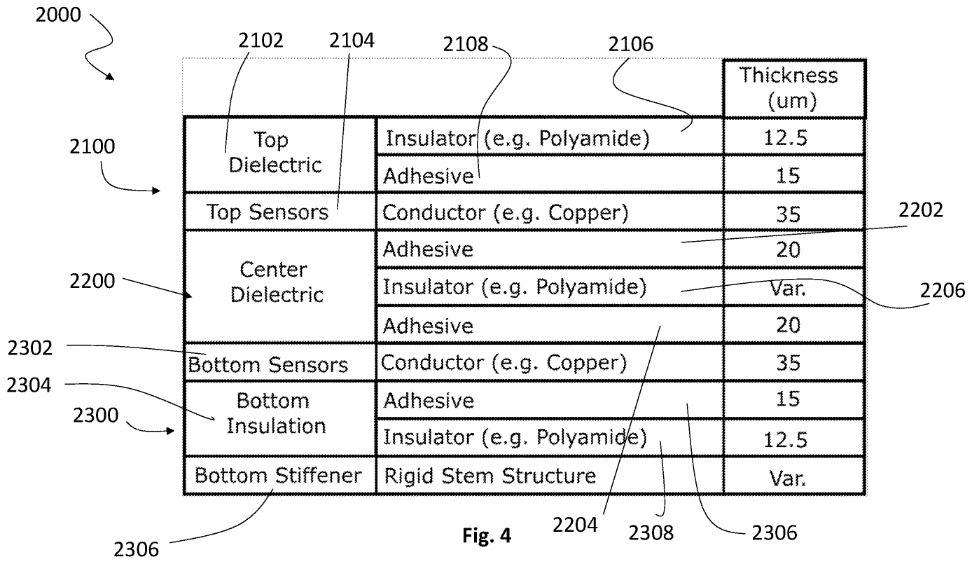

The sensor 1002 may comprise a layered structure. FIG. 4 illustrates in the form of a table, the layered structure 2000 of a generally planar, flexible sensor 1002 in one embodiment. For ease of reference the layers will be assigned relational references designating a “top” and a “bottom”, however it will be understood that in use the layers may be oriented so that they are not in a top-to-bottom arrangement. The top (or first) layer 2100 of the flexible sensor 1002 can include a dielectric sub-layer 2102 and a sensor sub-layer 2104. The top dielectric sublayer 2102 may be provided over, i.e., exterior to, the sensor sub-layer 2104. It can include an insulator sub-layer 2106 made of a suitable insulator material (e.g., polyamide nylon) with a thickness of 12.5 μm, and an adhesive sub-layer 2108 with a thickness of 15 μm. The adhesive 2108 of the top dielectric sub-layer 2106 is configured to attach the dielectric sub-layer 2102 to the top sensor sub-layer 2014. The sensor sub-layer 2104 is made from a suitable conductor material (e.g., copper), and in this example has a thickness of 35 μm. A bottom layer 2300 may be provided in mirrored arrangement to the top layer 2100. As can be seen from FIG. 4, in mirrored fashion in relation the top layer 2100, the sub-layers of the bottom layer 2300 include a sensor sub-layer 2302 which may be made of a conductor material (e.g., copper), followed by an insulation sub-layer 2304 which is exteriorly located in relation to the sensor sub-layer 2302. The insulation sub-layer 2304 includes an adhesive sub-layer 2306 with a thickness of 15 μm, and an insulator sub-layer 2308 made from a suitable insulator material (e.g., polyamide nylon) with a thickness of 12.5 μm. The bottom layer 2300 can also include a stiffening component 2306. The stiffening component 2306 may be s a rigid stem structure of variable thickness. The top and bottom layers 2100, 2300 provide the opposite sides of the planar sensor 1002.

A central dielectric layer 2200 is provided between the top and bottom layers 2100, 2300. This serves to electrically insulate the top and bottom layers 2100, 2300. The central layer 2200 may include two adhesive sub-layers 2202, 2204 with a thickness of 20μm and an intervening insulator sub-layer 2206 made from a suitable insulator material (e.g., polyamide nylon). The thickness of the insulator material may be variable.

The thicknesses and materials mentioned in the above are examples only. In other variations of the invention, the material and layer composition of the flexible sensor 1002 may vary depending on the desired thermal, mechanical, structural and/or evaporative properties of the leaf of which the sensing device 1000 is emulating. This can involve tuning of the size, thickness, surface finish, stiffening layer, material composition and the layout of the flexible sensor 1002. Sprays rely on the mechanical agitation of the crop canopy to deposit chemicals on leaves deep within the canopy. Therefore, biomimicry of the real crop leaves (particularly with regards to their mechanical and thermal properties) is advantageous. There may be certain minimum specifications that are desirable to prevent unwanted cross-talk between the top and bottom sensing layers, as well as provide sufficient mechanical protection to the conductive layers for them to operate on farms for months on end.

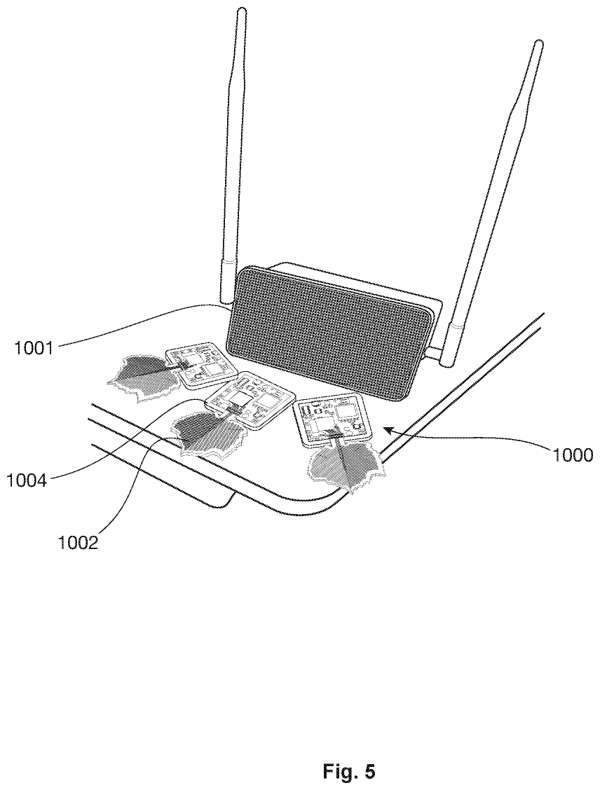

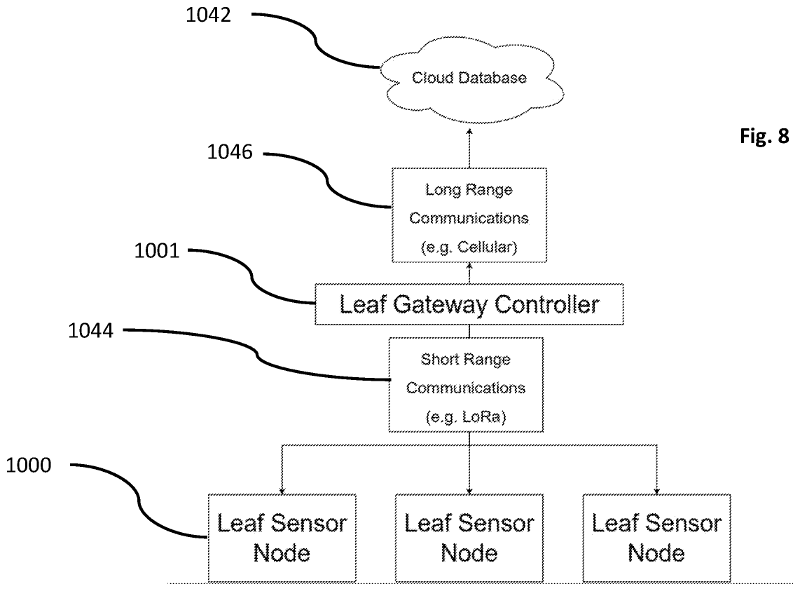

FIG. 5 illustrates an example of a system used for measuring the spray coverage of leaves in a crop field. The system can include a plurality of sensing devices 1000 and one or more gateway devices 1001. The gateway device 1001 is configured to be in data communication from one or more of the plurality of sensor devices 1000, through a wired or wireless connection protocol (better illustrated in FIG. 8). The gateway device 1001 may be a networking router device or another suitable networking device. The communication between the gateway device 1001 and the sensing devices 1002 may be made via radio communication such as LoRa. Shorter range communication protocols such as Bluetooth® may be used if the gateway 1001 is sufficiently close to the sensing devices 1002. The gateway device or devices 1001 may further be configured to communicate with a remote computing or server system via a network communication protocol (e.g., via cellular connectivity, Wi-Fi, Low-Power Wide-Area Network etc), particularly in embodiments where the data are being analysed remotely (i.e., offsite at a location away from the farm) or where remote monitoring is desired. It is important to note that in practice, the gateway device 1001 is placed in an elevated outdoor position where it does not get sprayed, to reduce the instances of unwanted error readings. For example, a rainfall sensor included in the gateway device 1001 can be used to obtain rainfall readings which can be used for error rejection algorithms which process the leaf sensor data.

FIG. 6 illustrates in one example, a block diagram representation of the operations of the flexible sensor 1002 and controller device 1004 of the sensing device 1000 shown in FIGS. 1 to 5. The controller device 1004 includes a processor 1018 which may be a microcontroller core. The processor 1018 performs the processing function of the controller 1004 which can include storing, reading and/or processing information received obtained by the probes on the flexible sensor 1002 of the sensor device 1000. The processor 1018 may include computing components such as a central processing unit (CPU), read only memory (ROM) and/or a random-access memory (RAM). The controller device 1004 includes a local wireless communication subsystem 1028 that facilitates communication with the gateway element 1001. The controller 1004 may be configured to store data received from the sensor 1002 in a data and power subsystem 1020. The controller device 1004 includes a capacitive sensing sub-system 1024 configured to interface with the sensor elements, being sensor probes, provided on the sensor 1002. The capacitive sensing sub-system 1024 provides the electrical excitation to the probes on the sensor 1002 and receives the excitation response of the probes to obtain the capacitance measurement.

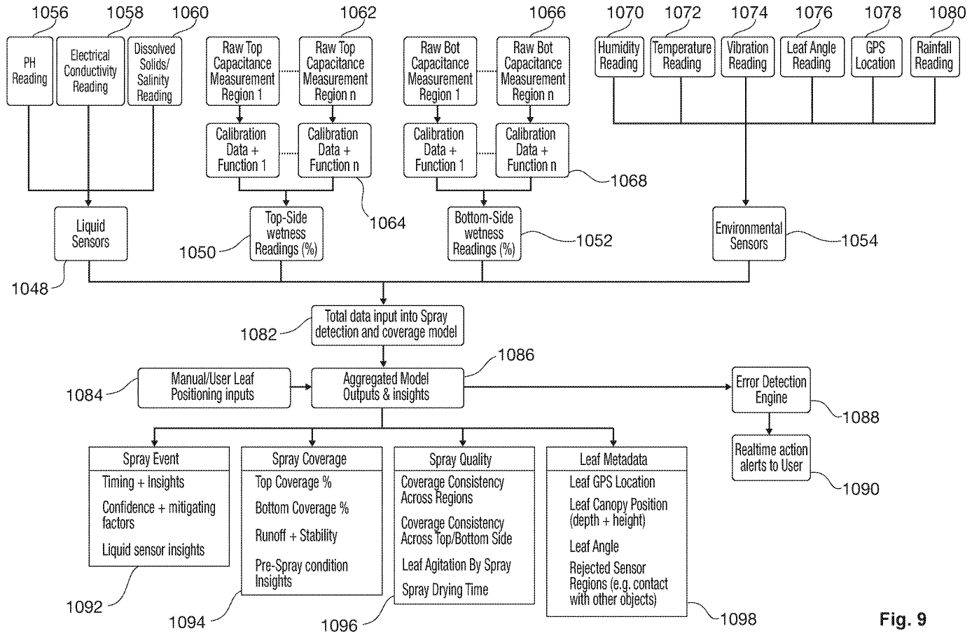

The controller device 1004 also includes a power and data input subsystem 1020 configured to power the processor 1018. It may provide power toa battery and charger subsystem 1022 to be stored therein. As better shown in FIG. 9, the environmental sensor 1026 (also shown in FIG. 6) and environmental sensor 1054 can allow for the capture of “hyperlocal” baseline environmental parameters. Here, “hyperlocal” parameters means those measuring the environmental conditions take into account the shading within the canopy, trapped moisture, lack of wind, etc. These readings are “hyperlocal” as they are not representative of the actual climatic conditions on the farm that contribute to crop growth. Rather they are representative of the conditions at the location of the leaf probe and therefore can be used to compensate its readings.

The environmental parameters may include one or more of: moisture, humidity 1070, temperature 1072, vibration 1074, leaf angle 1076, GPS location 1078 and/or rainfall reading 1080. The parameter values are used by the processing algorithm to identify and compensate for the effects of these environmental readings, for a more accurate spray detection. The environmental sensor subsystem 1026 may include an accelerometer or inertial sensors. This allows the user to measure the agitation or vibration of the leaf during a spray event, which is important in determining how well a sprayer is agitating the canopy, how well the pesticide may penetrate within it, as well as baseline leaf angle information 1076. The accelerometer can also determine the angle of the leaf, which will be used in the determination of the top and bottom (leaf) side spray penetration, and the sprayer height calibration. It may also be used in the detecting and notifying if and/or when a sensor device 1000 falls off. The environmental sensor sub-system 1026 may include a GPS module. Data from the GPS module can enable automated mapping of the above data for ease of data visualisation. The environmental sensor subsystem 1026 can also include sensors for sensing properties of liquids, such as sensors related to PH and conductivity, to provide increased confidence of spray events and composition, as well as rejecting irrigation sprinklers from being detected as sprays if the spray from the irrigation sprinklers is not desired to be detected or measured. However, the sensing devices disclosed herein may be used as irrigation sensors.

The sensing device shown in FIG. 6 is configured for processing the data from the leaf sensor 1002 and the environmental sensors (if provided). Particularly in embodiments where the environmental sensing sub-system is provided onboard the controller, this has the benefit of ensuring the environmental data reading is relevant to the location of the local processing “node” as the controller 1004 can be understood to be. By doing local processing at the “node” level, this also reduces the processing load at the gateway device, at a remote system, or both. This can further help to reduce the amount of data which needs to be provided to the gateway device or the remote system. However, some or all of the processing may be done at the gateway device, or a remote computing system if the gateway device connects to a remote system, or both.

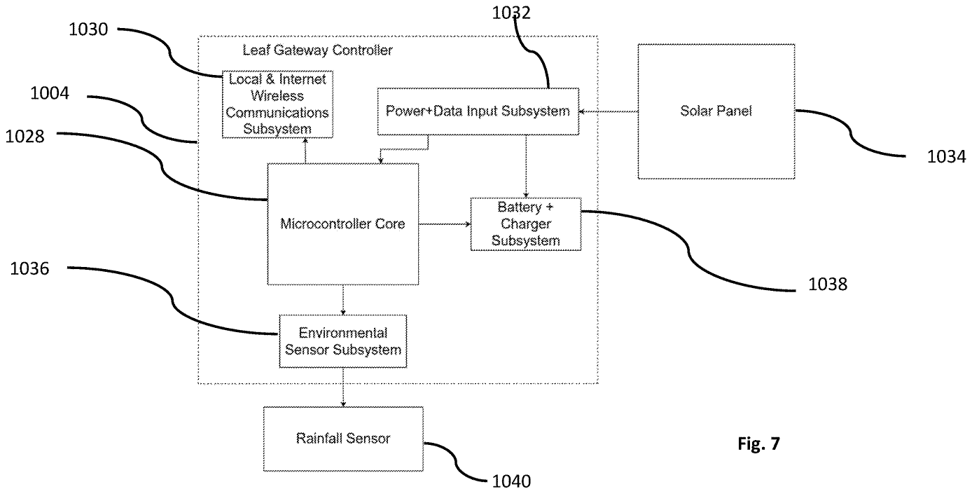

FIG. 7 schematically illustrates an example of a gateway device 1001 that is configured to communicate with one or more sensing devices 1000. The gateway device 1001 can include a processor 1028 which may be part of a processing core to store, read and/or process information received from the plurality of sensor devices 1000. The gateway device 1001 includes a communication subsystem 1030. The communication subsystem 1030 may be configured to enable “local” communication with the one or more sensing devices 1000. The communication subsystem 1030 may also be configured for wireless communication using a network protocol (e.g., Wi-Fi, 3G, 4G, 5G) that facilitates communication with a remote system, such as a remote data repository which may be a cloud database 1046 (see FIG. 8). The gateway device 1001 may be able to store data, power, or both. For example, it may include a power and data input subsystem 1032, which optionally may be powered by a solar panel 1034 to store charge in a battery and charger subsystem 1038. The gateway device 1001 may include an environmental sensor subsystem 1036. The environmental sensor subsystem 1036 may be configured to receive data from an external rainfall sensor 1040 which helps capture of rainfall data at the location of the farm where the spray sensing system is installed. In some embodiments, the environmental sensor subsystem 1036 includes the rainfall sensor. The rainfall data is useful to assist in rejecting false positive readings where the wetness is caused by rainfall rather than spray coverage. The environmental sensor subsystem 1036 may further include other sensors related to, e.g., temperature and/or humidity to measure the environment conditions during a spray event.

FIG. 8 illustrates an example of a data pathway from the gateway device 1001 and the plurality of sensing devices 1000 to a remote system which in this example is a cloud database 1042. As shown, information is processed and/or transmitted from the plurality of leaf sensing devices 1000 to the leaf gateway device 1001 via a short-or near-range communication protocol 1044 (e.g., via LoRa). The gateway element 1001 can then process and/or transmit information to the cloud database 1042 via a longer-range communication protocol 1046 (e.g., cellular connectivity). While in use, the multiple sensing devices 1000 will be spread out across a farm while communicating with the gateway device 1001 that then aggregates and transmits the data to the cloud database 1042. In some embodiments, multiple gateway devices 1001 may be provided, each for processing/transmitting data from one or more corresponding sensing devices 1000. The data sent to the remote storage may be retrieved by a remote computing system such as server system for use in making further analyses. The data and/or results from any analysis may be made accessible to users via a user interface.

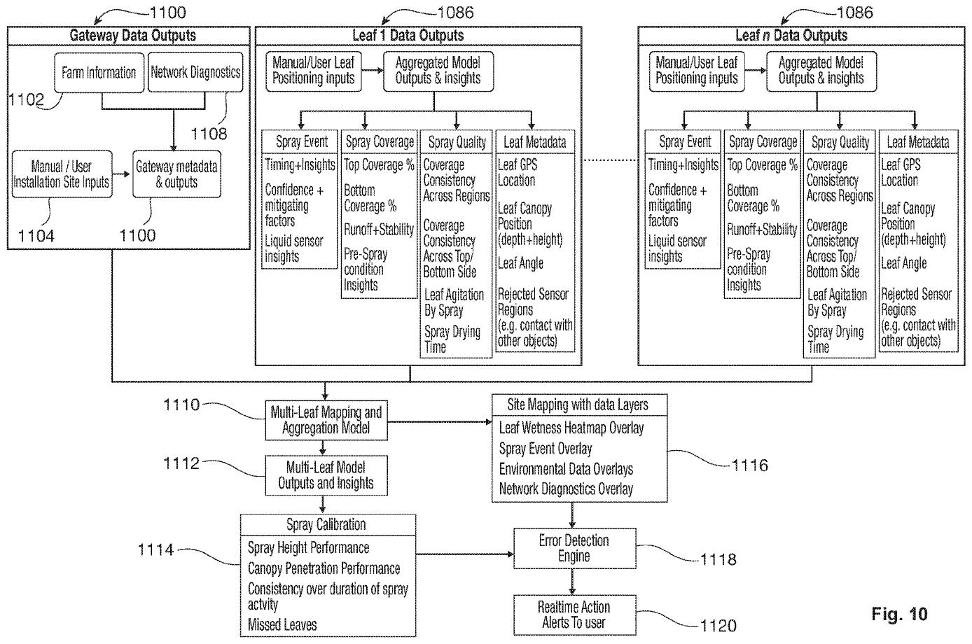

The gateway device 1001, or a remote system (if included), or both, may be configured to determine a multi-leaf data model 1112 (see FIG. 10) which may be made accessible to users via a user interface, such as a web-based or mobile application providing a dashboard. This may be provided in real-time. E.g., the user can then choose functions to analyse the multi-leaf model data to generate insights related to the spray coverage in the crop field in real-time. In some forms of the invention, the system is able to generate readings at set intervals, e.g., at a sampling rate of every 10 minutes. The frequency of the processing may depend on the battery capacity of the sensing devices 1000 or the gateway device 1001 used. The user may be enabled to alter the sampling rate by manually adjusting the settings built into the sensing devices 1000 and/or gateway device 1001 depending on the use-cases of the sensing devices 1000 (e.g., gathering information overnight vs during the day).

FIG. 9 illustrates an example of how information gathered from a sensing device 1000 is processed. The processing can occur locally within the controller 1004 of the sensing device 1000 but it can also optionally instead occur when the information is received by the gateway device 1001. The same processing may be done at both the level of the sensing device 1000 and the gateway device 1001, for redundancy. Further alternatively, each sensor device 1000 or gateway device 1001 may be responsible for some of the processing, to share the processing across the two levels.

In the depicted example, the data received by the gateway device 1001 include the liquid sensor data 1048, the topside (or “first side') wetness data 1050, the bottom side (or ”second side') wetness data 1052 and the environmental sensor data 1054. The liquid sensor data 1048, this may include one or more of PH readings 1056, electrical conductivity readings 1058, and dissolved solids/salinity readings 1060 (as shown in FIG. 9). The top-side wetness data 1050 can include information related to the raw top-side capacitance measurements 1062 detected from each capacitive sensing arrangements 1024 in the one or more sensing regions 1006 on the top (or “first”) face 1007 (see FIGS. 1, 2C) of the flexible sensor 1002, and calibration data 1064 based on the one or more sensing regions 1006 on the top face of the flexible sensor(s) 1002. The bottom (or “second”)-side wetness data 1052 can include information related to the raw bottom (or “second’) side capacitance measurements 1066 and calibration data 1068 both related to the detected information from each capacitive sensor arrangements 1024 in the one or more sensor regions 1006 on the bottom (or “second”) face of the flexible sensor(s) 1002.

The environmental sensor data 1054 received from the environmental sensor subsystem 1026 can include information related to humidity 1070, temperature 1072, vibration 1074, leaf angle 1076, GPS location 1078 and/or rainfall 1080. The combination of the liquid sensor data 1048, top-side wetness data 1050, bottom-side wetness data 1052 and/or environmental sensor data 1054 may be inputted into a spray detection and coverage determination model 1082. The spray detection and coverage model 1082 alongside with leaf positioning data 1084 are processed by executing machine instructions stored in the microcontroller core 1018 of each of the plurality of sensor devices 1000 to generate aggregated outputs and insights model 1086, related to the leaf sensor devices 1000. The leaf positioning data may be manually defined by the user during or after installation, or it may be predefined, or it may be automatically detected.

The output from the aggregated outputs and insights model 1086 may include spray event data 1092, spray coverage data 1094, spray quality data 1096 and/or leaf metadata 1098. Spray event data 1092 can include information related to the timing of the spray event, and confidence and mitigating factors and liquid sensor insights. Here, “confidence” refers to the spray detection engine's confidence of accurately detecting a spray event. It could be affected by mitigating factors such as rainfall recorded nearby, or a lack of a spray detection by other leaf sensors on the same farm. Another example of a mitigating factor may be one or more parameters relating to the wind, as the wind could affect baseline sensor vibration readings, and in turn which could affect canopy penetration output. Other examples include detection of low leaf agitation, atypical leaf angle, high humidity, etc. The confidence or detection of the “mitigating factors” which could affect the confidence level may be presented to the user as useful information. They may also be useful in providing diagnostics if the sensing device erroneously detects a spray event.

The spray coverage data 1094 may include information related to the coverage percentage for both the top face and bottom face of the flexible sensor 1002, spray runoff and stability, and pre-spray condition insights. Examples of pre-spray conditions include but are not limited to: higher than expected baseline readings due to spray residue, existing moisture due to condensation or rainfall, non-ideal environmental conditions (e.g. non-optimal wind, temperature, or humidity). The spray quality data 1096 can include information related to the coverage consistency, which may be determined by determining a consistency of the readings across the one or more sensing regions 1006 of the flexible sensors 1002, the coverage consistency across the top and/or bottom faces of the flexible sensors 1002, the leaf agitation caused by the spraying event, and the time required for the spray to dry. The leaf metadata 1098 can include information related to the GPS location of the sensor leaf devices 1000, the canopy position of the leaf sensor device's 1000 (related to both depth and height), the leaf angle, and the rejected sensor regions (e.g., sensor regions that have made contact with other objects). The aggregated output and insights model 1086 outlined above can be subsequently sent to an included error detection engine 1088 that can calibrate the data and provide real-time alerts 1090 to the user, if the data indicate that the spray event is not proceeding smoothly and needs to be adjusted or stopped.

FIG. 10 illustrates an example of processing the information gathered from multiple leaf sensing devices 1000 and a gateway device 1001 in data communication with the sensing devices 1000. As mentioned previously, the processing can occur at the gateway device 1001, at a remote computing device, or a server system. The processing may include compiling the output from the aggregated leaf data outputs 1086 (depicted in FIG. 9) received from the plurality of sensing devices 1000 and the gateway data output 1100 from the gateway device 1001. The gateway data output 1100 may include gateway metadata 1100. The gateway metadata and outputs 1100 which may be generated by using as input, one or more of: farm information 1102, network diagnostics 1108 and/or installation site inputs 1104. These inputs may be manually inputted by the user. The gateway metadata 1100 and the ‘n’ number of aggregated leaf data outputs 1086 are together compiled into a multi-leaf aggregate model 1110. The output of the algorithms which implement the multi-leaf data aggregation model 1110 may be provided as input to algorithms which implement a multi-leaf outputs and insight model 1112 that is configured to output data related to, e.g. spray calibration information 1114 and a site mapping model with data layers 1116. The spray calibration information 1114 can include information related to the sprayer height performance, canopy penetration performance, row to row consistency, consistency over the direction of a spray event and/or missed leaves. The site mapping model 1116 can generate information that can include: a leaf wetness heatmap overlay, a spray event overlay, an environmental data overlay and network diagnostics overlay. The outputs of the site mapping model 1116 and spray calibration model 1114 can both be sent into an error detection engine 1118 that can be used to calibrate the results and/or send real-time action notifications 1120 to the user.

The use of multiple sensing devices 1000 allows for intelligent tracking and mapping of spray activity by reporting what areas are sprayed well, poorly or missed. There are a multitude of insights and resultant responsive actions growers can take to those insights based on the nature of the inconsistency. For instance, a farmer will be able to optimise their “water rate” to use less spray (a significant operating cost for farmers) while still achieving the desired level of coverage. Detection of clogs or errors in spray machinery is also a large value proposition, as they can be detected and rectified in real time, ensuring crops are not going unprotected. In other forms of the invention, the user can glean insights into the remnant chemical residue after the drying of the spray.

The baseline “Dry” state leaf wetness level for a leaf varies based on the size of sensing devices 1000 used. Calibration can then be performed to tune the “Wet” state to what is considered 100% coverage by a particular industry. By default, this can be set to the measurement recorded by a fully submersed leaf in water. Baseline ‘dry’ values will vary based on ambient humidity, and the onboard humidity sensing device 1070 can be used to compensate for this effect. Importantly, various residues can accumulate on the flexible leaf sensor 1002 and affect the sensi ng device's baseline capacitance reading. It is not always desirable to filter and compensate for these impacts, as they represent a real-world measurement that is relevant to overall leaf susceptibility to pests and the effectiveness of any spray event that is conducted on such a leaf. For instance, for particular products, post spray application, the solids in the spray remain on the leaf and can be detected by the sensor. Overtime, this can be analysed automatically or through a user's personal experience, to give a measure of a sprays continuing effectiveness and degradation, and therefore how soon the next spray should occur.

### Operation Modes

Embodiments of the sensing system may be configured to operate in different modes which have different power requirements. In these embodiments, the switching between different modes and the sensing data acquisition in these modes are preferably designed, to obtain a balance between conserving power and achieving an adequate temporal resolution of the data points.

In one general embodiment, the modes include at least a sleep mode and a normal mode. The sensing system is normally in a sleep mode with a minimal power consumption, but “wakes” to the normal mode which has normal operations. In one implementation, in sleep mode operation, the processors (e.g., gateway processor) is off, but the peripheral sensing regions remain on. The system transitions from sleep mode to normal mode at regular intervals, and/or when the sensing regions detect a potential spray event.

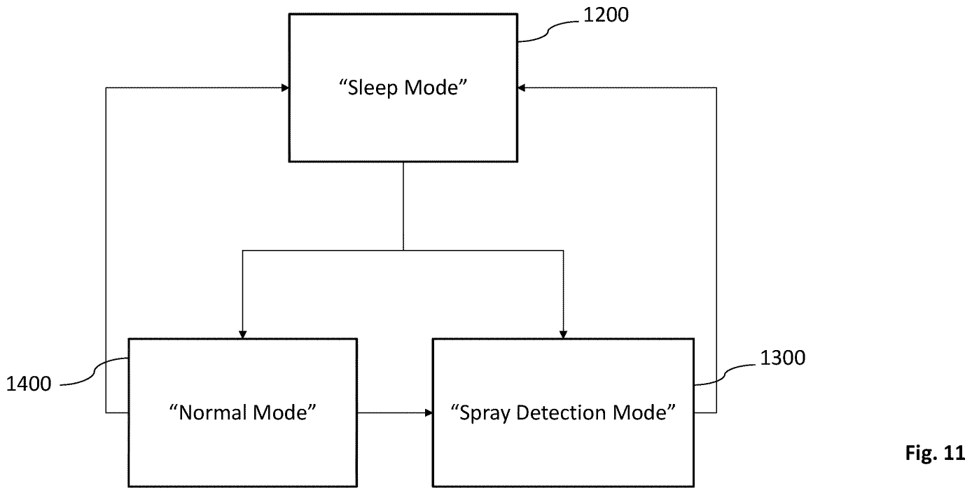

The modes may further include an intermediate operation mode between sleep mode and normal mode, with some processing functions turned on. An example is shown and discussed below with reference to FIGS. 11-14.

The sensor state diagrams illustrated herein can be implemented on either a system-wide and/or a single sensor device level depending on the user's specific use-case (e.g., the distribution of sensors, environmental and/or geographical considerations etc). The reader would appreciate and understand that the implementation of the sensor state diagram disclosed herein can be implemented using the plurality of sensing devices 1000 and/or in combination with the one or more gateway devices 1001 as previously disclosed herein. However, for the sake of simplicity, the implementation of the sensor state diagram described herein will be generally referred to as a “sensor system” with reference to the components described on the sensing devices 1000.

FIGS. 11-14 show the schematic of an example embodiment having three different modes of operation that can be configured into the disclosed sensor system, referred to herein as: “Sleep Mode” 1200, “Spray Detection Mode” 1300 and “Normal Mode” 1400. The spray detection mode is an intermediate mode between sleep and normal modes. In this example, the spray sensing system is configured into a ‘first’ default mode of operation referred to herein as Sleep Mode 1200.

Referring to FIG. 11, in the sleep mode, the spray sensing system obtains readings from the sensing devices 1000 in the system (1204). There may be a pre-defined duration between each reading (as further described herein). This duration, in one example, is one second as set by a timer, and the system reads the sensor data (1204) every time the timer elapses (1202).

The use of Sleep Mode 1200 can advantageously result in a dramatically reduced level of power consumption (e.g., requiring only a <50 uA current) as the more battery-intensive processing components of the sensor system (e.g., the microcontroller core 1018, environmental sensor subsystem 1026 or GPS unit etc) are not in operation or switched off, while the peripheral capacitive sensing components (e.g., the leaf sensor probe 1002) that are less battery-consumptive are still in operation. In this mode, the reading values are compared against each other but the other processing functions may be switched off.

The system transitions from the sleep mode 1200 to the spray detection mode 1300 when a first wake-up condition is met, and transition from the sleep mode to the normal mode 1400 when a second wakeup condition is met. In the sleep mode 1200, when the sensor data is read from the leaf sensors, the system determines whether the readings meet the first wake-up condition. In one implementation the first wake-up condition is set where newly read value(s) exceed the previously read value(s) by at least or more than a minimum threshold (1206). This threshold may be set as absolute value(s) or may be sent as a percentage of the previous value(s), e.g., 10%. If the first wake-up condition is met, the system transitions into a spray detection mode 1300. Different first wake-up conditions for transitioning into the spray detection mode 1300 may be used instead. E.g., this could be satisfied when the current time reaches a scheduled time for spray operation. The first wake-up condition may require multiple criteria. As a non-limiting example, the newly read value(s) may need to exceed the previous value(s) by at least 10% and the newly read value(s) need to be above a minimum value.

As described above, the system may have multiple sensing devices and each sensing device may have multiple sensing regions. Therefore, the value(s) being compared to assess the example first wake-up conditions may be value which statistically represents the readings. For instance, the readings may comprise a representative value from the multiple sensing regions. Each sensing device may have a representative value taken from the readings of the sensing regions on both sides, or one value for each side. In turn, a representative value taken from the values computed from the readings of the multiple sensing devices may be used for the comparison in assessing wake-up conditions. The representative value may be, e.g., a median or an average value. Statistical outliers from the readings may be eliminated prior to computing the representative values.

The second wake-up condition, for determining when to transition from the sleep mode 1200 to the normal mode 1400, may be set by a wake-up timer, such that when the wake-up timer elapses, the system goes into the normal mode 1400. It will be understood that the exact second wake-up condition is not considered to limit the general scope of the disclosure.

When both first and second wake-up conditions are met, the system may go into the normal mode.

The system may utilise an internal logic to define how to switch between the three modes. As the spray detection mode is intended to be less energy intensive than the normal mode but still have some processing functions, the design of this logic allows the system to be designed to balance between reduced power consumption and better temporal granularity in processing.

In the particular example shown in FIGS. 11-14, depending on the readings obtained by the peripheral sensing components 1204, or the built-in timer system (as described herein), the sensor system can change its mode of operation into either Spray Detection Mode 1300 or Normal Mode 1400.

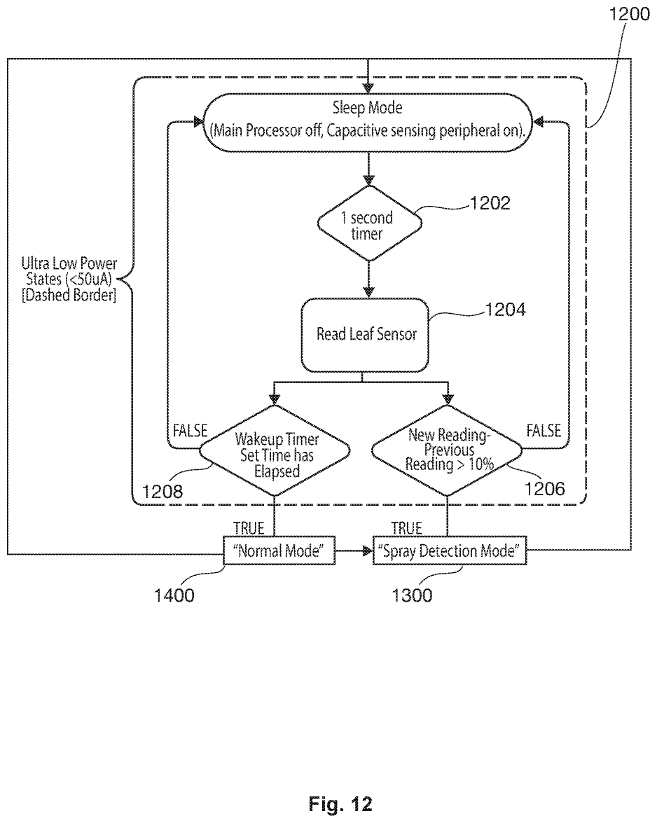

FIG. 12 illustrates an example of the sensor state diagram of FIG. 11 with a detailed implementation of Sleep Mode 1200. In a preferred example, the main processor components (e.g., the microcontroller core 1018 or local wireless communication subsystem 1028 etc) are turned off while the peripheral sensor capacitors (e.g., the leaf sensor probe 1002 and/or capacitive sensing subsystem 1024) would be kept on. In other variations of the invention, the user can choose which specific subsystem components are kept on and which subsystem components are turned off while the sensor system is operating in Sleep Mode 1200.

A pre-defined timer 1202 is configured to control the frequency of data reading from the peripheral leaf sensors 1204 (or the duration between each reading) while in Sleep Mode 1200. In an embodiment, the timer 1202 is set to take the sensor readings (1204) every 1 second. The duration of timer 1202 may be set to different values, depending on the user's specific use case. The 1 second frequency has been used in field trials in vineyards.

The system determines whether the new (i.e., current) reading value exceeds the previously read value by more than 10% (1206). This is chosen to try to tell a potential spray event from other events contributing to wetness, e.g., rain or condensation. The choice also depends on the type of crops being monitored. In other embodiments, the percentage difference or minimum threshold between the current reading and previous reading from the peripheral sensor 1206 may be adjusted (e.g., 5%, 8%, 15% etc) depending on the desired implementation of the sensor system. This is the first wake-up condition in this example. If this is satisfied, the system goes into spray detection mode operation 1300. However if the first wake up condition is not satisfied, then the system remains in sleep mode. The system also checks whether a wake-up timer has elapsed (1208). This is the second wake-up condition for this example. If the second wake-up condition is satisfied, the system goes into normal mode 1400. The wake-up timer may be initialised to a wake-up time period. This may be pre-set automatically or user set. The initial time period in this example is 5 minutes. When the wake-up timer elapses (second wake up condition met), the system goes into normal mode operation. The duration of the wakeup timer parameter 1208 can be adjusted according to the user's desired implementation of the sensor system in their specific operating environment.

If neither of the first or second wake up conditions are TRUE (i.e., satisfied), the mode of operation thus stays in Sleep Mode 1200. If both first and second conditions are satisfied, then an internal logic is used to determine the mode to which the system will transition. In one embodiment, this logic is set at least in part by the value of a flag. The value of the flag may determine whether the system goes into normal mode 1400 or spray detection mode 1300 when both first and second wake-up conditions are met, as will be described later. The value of the flag may be changed during the normal and/or spray detection mode operation. The reader would appreciate, however, that the logic between the modes of operation can be adjusted depending on the user's implementation of the sensor system in their specific environment.

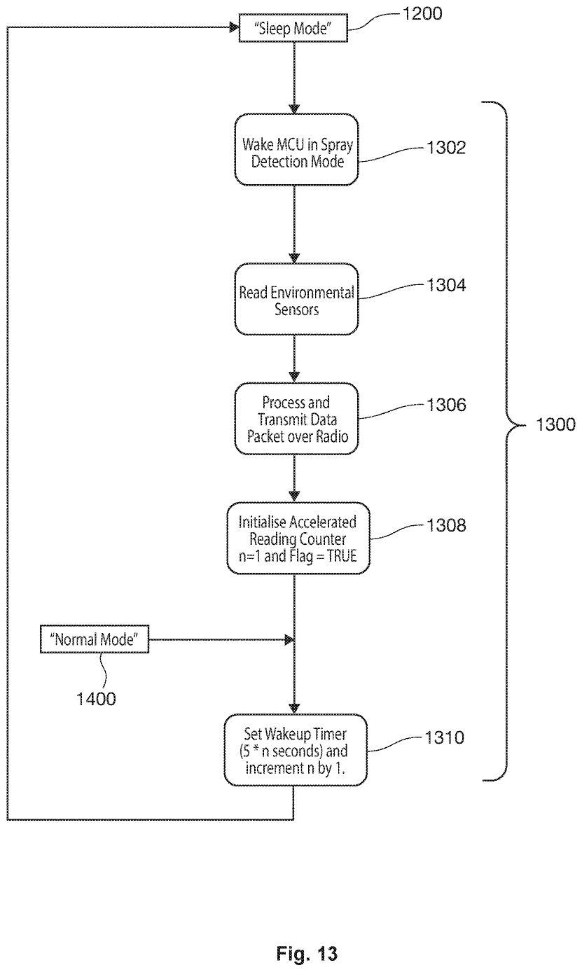

FIG. 13 illustrates an example schematic for a Spray Detection Mode 1300 according to one embodiment. In the Spray Detection Mode 1300, the main controller unit components are turned on (1302). The sensor system reads data from the environmental sensors (1304) and process and transmit the data packet acquired from the peripheral sensors 1204 and/or the environmental sensors (1304). The transmission may be over radio 1306 and/or other forms of wireless communication protocols (previously disclosed herein), to the main system (e.g., gateway control 1001, cloud database 1042 or central server).

After the sensor system has read the data transmitted the data packet(s) (1306), the sensor system initialises an accelerated reading counter “n”, and update an Accelerated reading flag to be “TRUE” (1308). As will become clear, in the described embodiment the “accelerated reading flag” is used to partially set the logic of the transitioning of the operation between modes. Next, the wake-up timer (previously referenced in 1208 in FIG. 12) is set to (5×n) seconds and the accelerated reading counter “n” is incremented by 1 (1310). This has the effect of incrementing the wake-up timber by 5 seconds each time the counter n is incremented by 1. However the amount of time incremented can be changed. Thus, the reader will appreciate that the general logic of this implementation of spray detection mode 1300 involves the sensor system:
initialising an accelerated reading flag to be “TRUE” (at 1308) to mark the start of an accelerated spray event, where reading and processing of the sensor data occurs more frequently than the initialised time frame which in this example is every 5 minutes; and
incrementing an accelerated reading counter “n” (at 1310) to track and to obtain readings related to an accelerated reading or detected spray event every (5×n) seconds, as “n” increments from 1 to 60, so that the timer does not exceed a 5 minute duration.

After the wake up timer is set to 5×n seconds and n is incremented (1310), the system returns to the sleep mode 1200. This means that when the wake-up timer of 5×n seconds elapses, because the “accelerated reading” flag is set to True, the system enters normal mode (from the determination of the second wake-up condition, made at step 1208) more frequently than frequency set by the initial wake-up timer value (in this example, 5 minutes).

By performing a reading and processing the data at a time points set by the incrementing wake-up timer durations set by 5×n (that is, set by the value of counter n), it is possible to more readings and a higher number of data points closer to the start of an event determined as a detected spray event (by the first wake-up condition being satisfied), with the reading and processing becoming less frequent as time goes on, vs later on when the spray chemical has already evaporated, until the maximum wake-up timer value is reached. In some forms, the sensor system can perform the readings at a consistent rate (e.g., once every 5 seconds) or at different rates or frequencies depending on, e.g., which aspect/period of a spray cycle is of particular interest to the user.

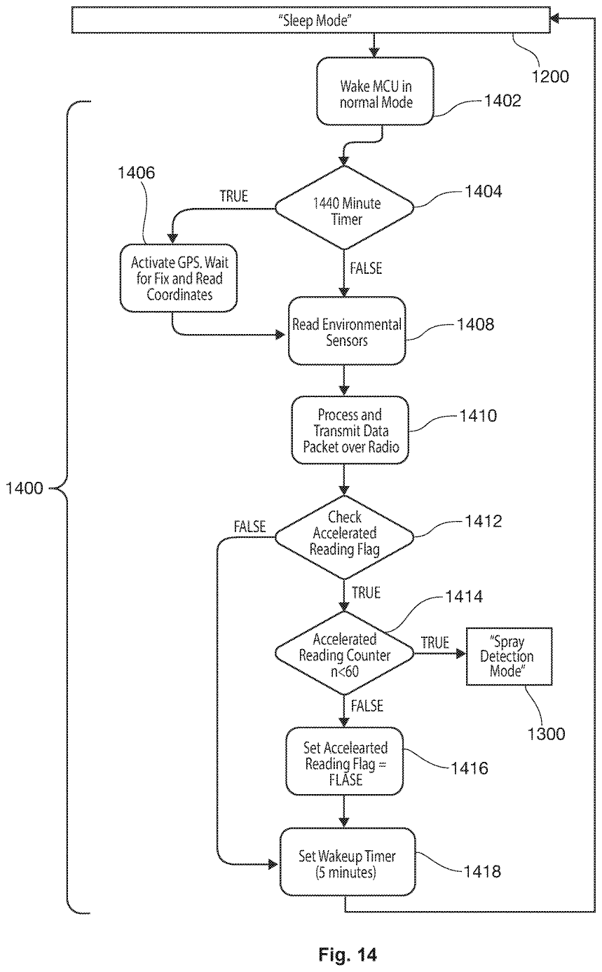

FIG. 14 illustrates an example of the sensor state diagram of FIG. 11-13 with a detailed implementation of Normal Mode 1400. As described previously, when the wake up timer elapses, the spray sensing system transitions into Normal Mode 1400. In Normal Mode 1400 the sensor system activates the main controller unit (or the more batter-intensive components) in a similar manner to Spray Detection mode. Optionally, the system activate the GPS function or waited, fixed and/or read the coordinates from the GPS unit (1406), if it has been more than 24 hours since it has done so. The 24 hour period is not fixed across all embodiments, and may instead be set to another time period. As GPS functions consume more power, it may be up to the user how frequently to enable the GPS functions in view of the acceptable level of power consumption. In the implementation shown, the system checks the value of a 24 hour timer or clock (1404) which may be re-set each time the GPS functions are performed, and only performs the GPS function when the timer has reached at least 24 hours or the 24-hour timer has elapsed (1406). After performance of the GPS functions, or without performance of the GPS functions, the system reads data from the environmental sensors (1408). It will be appreciated that some orders of the steps can be changed. For instance the system may read the sensor data (1408) before checking the timer or clock (1404) to determine whether GPS functions should be performed. The sensor system processes and transmits the data read from the peripheral sensors (1410) and/or the GPS. This may be over radio 1410 or through other wireless communication protocols to the main data-receiving system (e.g., gateway control 1001, cloud database 1042 or central server) as previously described herein.

The sensor system checks the value of the accelerated reading flag (1412). If the accelerated reading flag is not activated or its value FALSE, the sensor system will re-set the wake-up timer to the maximum duration, e.g., 5 minutes (1416). If the flag has been activated or its value is TRUE, the system checks whether the counter n is less than its maximum, in this case 60 (1414), as this indicates that the wake-up timer has not been incremented to the maximum duration, If the timer counter n is less than the maximum value, the system increments n (1310), after which the system returns to sleep mode 1200. If n has reached its maximum value, the system re-sets the accelerated reading flag value to FALSE, i.e., deactivates accelerated reading (1416). The timer is then reset to the maximum time (1418). Once the timer is reset to the maximum time (1418), the system goes back into sleep mode 1200. The reader will appreciate that the general logic behind this example of the implementation is that if accelerated reading is not activated or the accelerated reading flag is still FALSE) during normal mode 1400, the sensor system will return to sleep mode 1200.

The reader will understand that the general logic of this specific embodiment of the sensor system is to:
acquire data in an accelerated reading operation for up to 5 minutes. In the depicted example the reading times are set by the incrementing values of counter n, e.g., every (5×n) seconds. The maximum value for n and also the time multiplied by n, thus determines the duration of the accelerated reading operation. In the accelerated reading operation, the system switches between normal mode, spray detection mode, sleep mode, at times set by the counter n which keeps incrementing. The reader will also understand that other implementations of the above sensor state diagram can be contemplated depending on the user's specific use-case. For example, the maximum value for n does not necessarily need to be set on the basis of the maximum allowable wake-up timer value. For instance, it may be that the sprays or moistures tend to evaporate in the first 3 minutes, then n and/or the wake-up timer variable multiplied by n (i.e., 5 seconds in this example) may be set so that the accelerated reading duration is no more than 3 minutes. Also, the pre-set wake-up timer variable (i.e., of 5 seconds) can be prolonged or shortened during/after a detected spray event.

In use, the disclosed embodiment of the sensor state diagram of Sleep Mode 1200, Spray Detection Mode 1300 and Normal Mode 1300 can result in the sensor system improving its battery life while being able to accurately capture the desired data related to a spray event. Various operational parameters, such as the maximum wake-up timer value, counter n wake-up timer variable, the minimum time duration between GPS operations, etc, can be adjusted for the sensor system to be optimised for different crops and/or environmental conditions (e.g., drier region with faster typical real world evaporation rates, versus a more humid region).

### Sensor Arrangement Desciprtion

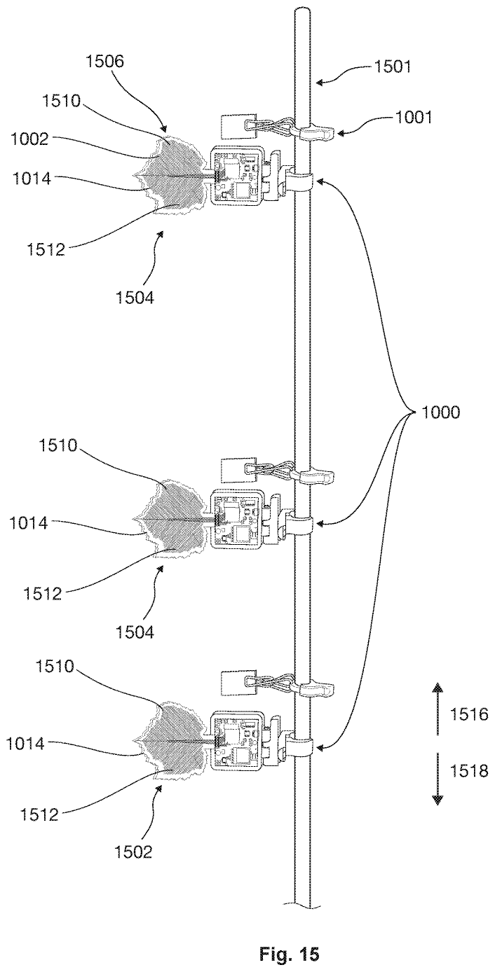

FIG. 15 illustrates an example of an arrangement of the plurality of sensing devices 1000 feeding data to a gateway apparatus 1001. The sensing devices 100 may be installed or arranged onto a columnar apparatus 1501 located amongst the canopy, in this case in a viticultural field. In this example, the sensors 1000 are arranged at 3 distinct locations, regions or heights. The sensing devices therefore include a bottom sensing device1502, a middle sensing device 1504 and/or a top sensing device 1506. They are respectively arranged at in the “bunch zone”, “deep canopy zone” and “top canopy zone”. This vertical demarcation is frequently used in viticulture. For other crop types, the zone demarcation may be different. The sensor arrangement allows the user to advantageously obtain readings corresponding to these distinct regions of a given canopy. In the illustrated example of viticulture or use in a vineyard canopy, the top canopy sensor 1506 can provide data in relation to the “top canopy zone”, where the new growth from the canopy tends to be located, the middle canopy sensor 1504 can provide readings in the ‘deeper’ canopy (i.e., more moisture in the middle region can indicate good spray penetration into the canopy) and the lower canopy sensor 1502 can provide data on the “bunch zones” or lower growths (which is typically an important fruiting zone height where grapes are formed in viticulture).

In some forms, the arrangement of the plurality of sensing devices 1000 can be used in other forms of agriculture that are not strictly limited to viticulture (e.g., horticulture) and with other forms of crops (e.g., wheat, different types of fruit orchards, nuts etc). In other forms of the invention, variations in the number of sensing devices 1000 used are also contemplated within the scope of this disclosure as they may vary depending on the user's specific use-case (e.g., the use of 2 or more sensors 1000 on a given apparatus 1501). Furthermore, other forms of supporting apparatuses 1501 are contemplated within the scope of this disclosure-e.g., poles, columns etc.

In the example shown in FIG. 15, the plurality of sensing devices 1000, when installed, are arranged with the tip 1014 of the leaf probe 1002 pointing down or in the direction parallel to the direction of the rows of crops in the field. In vineyards the rows are often in the North-South direction.

In the below, the use of relative directional terms (e.g., bottom, middle and top or lower, middle, and upper) is used to describe the relative position and orientation of the sensing devices 1000 as shown in FIG. 15. In FIG. 15, he general upper/top/up direction (arrow 1516) is in the direction of the sky. The lower/bottom/down direction (arrow 1518) is in the direction of the ground. These directions may not necessarily be vertical and the orientation of the leaf sensors of the sensing devices 100 are not necessarily horizontal. The exact orientation depends on factors such as the topology of the field, and how the sensing devices are installed relative to the ground level and ground orientation. Other variations in the position or orientation of the sensing devices 1000 are contemplated within the scope of this disclosure depending on the user's specific situation.

In some forms, the plurality of sensing devices or probe faces are orientated to face substantially in the same direction. In the example illustrated in FIG. 15, the leaf sensors 1000 are generally at a 90 degree angle to the sky-ground direction, so that a first edge region 1512 of a given sensor probe face 1002 points towards the direction of the ground and a second edge region 1510 points towards the direction of the sky, This sets the faces of the leaf sensors generally oriented toward the sprayer as the sprayer goes through the rows of the crops, to facilitate the measurement of the spray coverage. The two faces of a leaf sensor may be sprayed at the same pass or at different passes, depending on the configuration of the spray equipment. If the sensor readings from the leaf sensors arranged at a particular zone are significantly below those of others, then this indicates that the spray nozzles spraying into that one may need to be adjusted or checked for proper functioning.

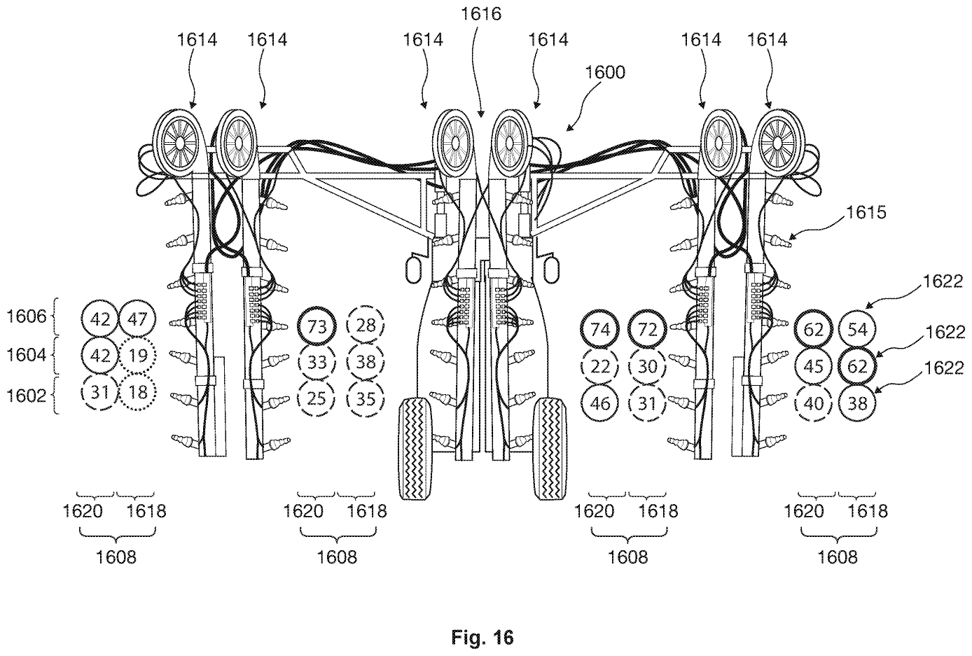

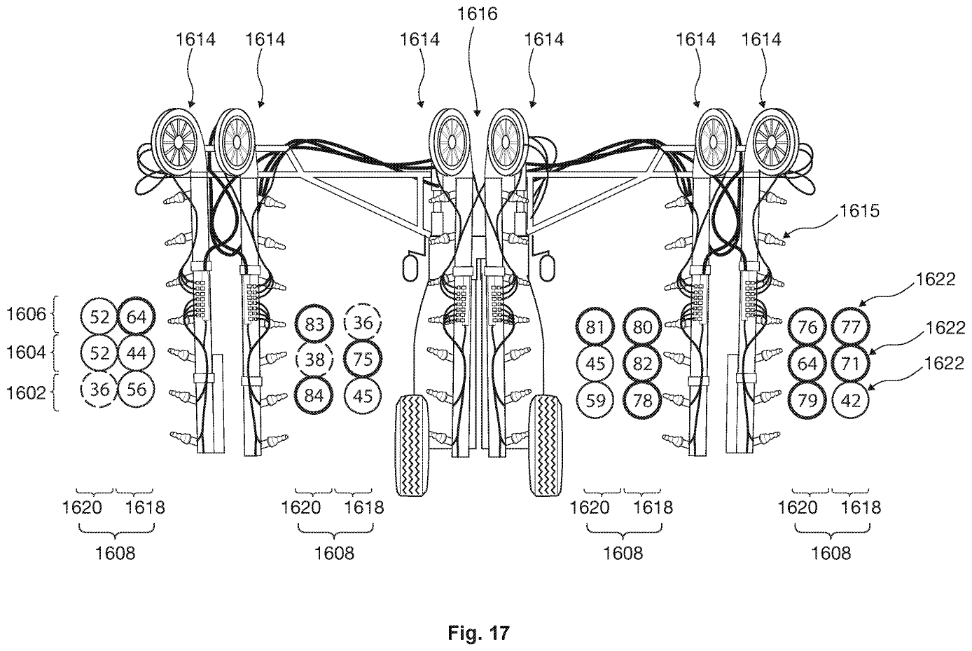

FIGS. 16 and 17 shows an example of a display of data readings in a user interface or dashboard. The readings are from a sensing system, with sensing devices arranged along four columns 1608, with three sensing devices in each column, arranged at the three “zones” 1602, 1604, 1606 as described previously. Each sensor provides two readings 1618, 1620, one corresponding to each face. Here the readings are a representative reading from the multiple sensing regions (e.g., median, average, etc). In generally preferred embodiments, the readings are presented in an arrangement that mirrors their locations in the vineyard. These are overlaid over an image of the sprayer 1616 in the vineyard. Arranging the interface in this way provides an intuitive way of matching the readings with the nozzles intended to target the zones or areas where the sensors are located, to allow the user to see at a glance which nozzle(s) may need servicing or checking. The spraying machine device 1616 is typically used with a plurality of nozzle columns 1614. In this case the spray 1616 has 6 columns of nozzle 1614 hanging from the spray arms. In use the nozzles of each column will face toward a crop row, as the spray 1616 travels between rows. The reader would understand that the arrangement of the sensing device 1000 may be varied. Preferably the sensing devices will be arranged in order to present sets of sensor faces each oriented toward a nozzle column.

Referring to FIGS. 16 and 17, the position of each superimposed circle 1622 relative to the overall arrangement of the circles therefore represents the corresponding physical location of the “sensing face”. The numerical value displayed within each circle may be a numerical representation (e.g., a percentage) of the aggregate spray coverage of that spray region as measured by the sensing devices 1000. For example, FIG. 16 represents the spray coverage of the sensing arrangement obtained before a spray event, whereas FIG. 17 represents the spray coverage of the sensing arrangement obtained after a spray event has occurred. That is, the dashboard may provide separate interfaces to show the before spray event and after spray event readings. In some forms, the readings may be visualised in real-time, or retrospectively. The displayed readings may correspond to data points corresponding to peak spray coverages at the time of a spray event. In some forms, the readings before a spray event may be read to establish a base line. E.g., they can be acquired on a dry day, or over the course of several dry days. This allows the user to see that readings at or below this baseline level (e.g. 10, i.e., 10%) indicate that the crops are dry enough for them to be sprayed. In some forms, the super imposed circles 1622 can provide a colour-based representation of the level of moisture as measured by the sensing devices. E.g., the colour scale can range from red, orange, yellow to green in the order of low to high moisture measurements, which after the spray event indicates amounts of spray coverage).

An example of a method of measuring spray coverage using the above sensor arrangement is described as follows:
Obtain the moisture readings from the arrangement of sensor devices 1000 to determine a “baseline moisture reading” prior to performing a spray event (e.g., FIG. 16);
Determine whether the environmental conditions and/or baseline moisture readings are suitable for a spray event, (typically the preferred baseline is below 10%),
If the conditions and readings are ideal (e.g., reading at or below baseline, or only higher baseline within an acceptable range, with low wind condition and no rain anticipated), operate the spray device 1616 in the predetermined spray cycle; and
Obtain and analyse readings from the sensor device arrangement during and/or after the spray cycle event (e.g., as shown in FIG. 17), to check the effectiveness of the spraying, and use the visualisation to identify whether the sprayer needs checking, and where it may need checking (e.g., which nozzle(s) or nozzle column(s)).

The reader would understand that spraying into a canopy that is already wet is typically detrimental to the crop protection. A given leaf crop can only support a certain amount of moisture before the droplets coalesce and the phenomena of “run off” would occur, whereby the spray chemicals would non-ideally end up on the ground rather than staying on the leaf canopy itself. The disclosed sensing arrangement can therefore allow the user to make an informed decision in real-time on whether the initial “baseline” or environmental conditions are suitable for a spraying event or not.

In some forms, while in use, the spraying machine device 1616 would typically go through each row/column of the given field by following a ‘raster’ pathway (i.e., by going through each row/column in a zig-zag manner). By following this predetermined pathway, the user can monitor and diagnose the performance of each nozzle 1614 of the spraying apparatus 1616 over time by analysing the spray coverage of each leaf sensor probe 1002 received from each nozzle 1615. For example, if a given nozzle 1615 at a specific height or column is consistently spraying too little or too much, as the spraying apparatus 1616 iteratively follows the predetermined pathway through each row or column, the corresponding sensor readings 1622 in each row or column 1608 (or faces 1618, 1620) will over time consistently provide readings that reflects this abnormality. In some forms, the sensor arrangement may also allow the user to determine how to adjust the orientation or direction of the nozzles to obtain optimal spray coverage.

In some forms, the user can also advantageously visualise and understand the effects of external environmental factors during a given spray cycle. For example, with wind, if the sensors 1000 located towards the right side of the canopy field region (i.e., towards the right side 1612) all provide unusually low readings 1622 even after a spray event has been performed, the user will be able to determine (with a higher degree of confidence) that an adverse wind event has affected the spray coverage readings 1622. Variations and modifications may be made to the parts previously described without departing from the spirit or ambit of the disclosure.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e., to specify the presence of the stated features but not to preclude the presence or addition of further features in various embodiments of the invention.

1-38. (canceled)

39. A sensing device for sensing wetness, the sensing device comprising a sensor, the sensor having a main portion, the main portion comprising more than one sensing regions, the sensing device including a respective sensing arrangement for sensing wetness in each of the more than one sensing regions such that the wetness of each sensing region is independently sensed.

40. The sensing device as defined in claim 39, wherein the main portion has a layered structure.

41. The sensing device as defined in claim 40, wherein the layered structure includes at least a sensing layer and an insulating layer provided over the sensing layer.

42. The sensing device as defined in claim 39, wherein the main portion is shaped like a leaf.

43. The sensing device as defined in claim 42, wherein the sensor comprises a stalk region, configured to transmit data from the more than one sensing regions.

44. The sensing device as defined in claim 42, wherein the sensor is shaped by the leaf of a crop in relation to which the sensing device is intended to measure wetness.

45. The sensing device as defined in claim 39, comprising a controller device which is in data communication with the sensor.

46. The sensing device as defined in claim 45, the controller being configured to do one or more of: process data from the sensor, store data from the sensor, or transmit data from the sensor.

47. The sensing device as defined in claim 45, wherein the controller further comprises one or more environmental sensors configured for measuring, while in use, environmental data.

48. The sensing device as defined in claim 47, wherein measurement(s) from the more than one sensing regions are adjusted to compensate for environmental effects on the basis of the environmental data.

49. The sensing device as defined in claim 45, wherein the controller further comprises an accelerometer, a GPS module, or both.

50. A spray sensing system configured to measure coverage of a spray applied to a crop, comprising a plurality of sensing devices, for sensing wetness, each of the plurality of the sensing device comprising:
a sensor having a main portion, the main portion comprising more than one sensing regions, the sensing device including a respective sensing arrangement for sensing wetness in each of the more than one sensing regions such that the wetness of each sensing region is independently sensed.

51. The spray sensing system as defined in claim 50, further comprising a gateway device configured to receive data from the plurality of sensing devices.

52. The spray sensing system as defined in claim 51, wherein the gateway device comprises a processor which is configured to execute machine instructions to analyse data the plurality of sensing devices.

53. The spray sensing system as defined in claim 51, wherein the gateway is configured to be in wireless communication with a remote computing system.

54. The spray sensing system as defined in claim 51, wherein the gateway device further comprises one or more environmental sensors or is configured to receive environmental information.

55. The spray sensing system as defined in claim 50, wherein the plurality of sensing devices are orientated substantially in the same direction.

56. The spray sensing system as defined in claim 50, wherein the plurality of sensing devices are arranged in a plurality of sets, wherein each set comprises multiple sensing devices arranged or located in accordance with spray zones defined by the user.

57. A method of measuring coverage of a spray applied to a field of crop, the method comprising:
providing at least one spray sensing system configured to measure coverage of a spray applied to a crop, the system comprising a plurality of sensing devices attached to a canopy of the crops, each sensing device comprising:
a sensor, the sensor having a main portion, the main portion comprising more than one sensing regions, the sensing device including a respective sensing arrangement for sensing wetness in each of the more than one sensing regions such that the wetness of each sensing region is independently sensed;
wherein information data from the gateway device is processed to determine a spray coverage.

58. The sensing device as defined in claim 45, configured to have a sleep mode in which the sensing arrangements are in normal operation but at processing functions in the controller are at least partially off, so as to reduce power consumption of the sensing device in the sleep mode.
